(19) United States
(12) Patent Application Publication
(10) Pub. No.: US 2026/0244479 A1
(43) Pub. Date: Aug. 20, 2026

(54) LIVE PARTITION MOBILITY OF PLATFORM KEY STORE ENABLED INACTIVE VIRTUALIZED MACHINES

(71) Applicant: International Business Machines Corporation, Armonk, NY (US)

(72) Inventors: Ravikishore Krishnamurthy, Bangalore (IN); Shivarudrappa Satyanaik, Bengaluru (IN); Girish S. Shrigiri, Gulbarga (IN); Aparna V S, Bangalore (IN)

(21) Appl. No.: 19/055,965

(22) Filed: Feb. 18, 2025

(51) Int. Cl. G06F 9/455; H04L 9/08

(52) U.S. Cl. CPC G06F 9/45558; H04L 9/0894; G06F 2009/45562; G06F 2009/45583

(57) ABSTRACT

Live partition mobility of platform keystore (PKS) enabled inactive virtualized machines includes monitoring, by an interface residing within a hypervisor running on a processor, virtual machines requesting PKS slots. Whether a live partition mobility is to be performed of an inactive virtual machine that has a PKS slot is determined. Memory is allocated to the inactive virtual machine. PKS data associated with the PKS slot is replicated to the memory. Live partition mobility of the inactive virtual machine is performed using the memory that is replicated with PKS data.

### BACKGROUND

The present application relates generally to computers and computer applications, and more particularly to virtual machines and live partition mobility of inactive virtualized machines having enabled platform key store.

### BRIEF SUMMARY

The summary of the disclosure is given to aid understanding of a computer system and method of live partition mobility of platform key store enabled inactive virtualized machines, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

In some embodiments, a computer-implemented method includes monitoring, by an interface residing within a hypervisor running on a processor, virtual machines requesting platform keystore (PKS) slots. The method also includes determining, by the interface residing within a hypervisor running on a processor, that live partition mobility is to be performed of an inactive virtual machine that has a PKS slot. The method further includes allocating, by the interface residing within a hypervisor running on a processor, memory to the inactive virtual machine. The method also includes replicating, by the interface residing within a hypervisor running on a processor, PKS data associated with the PKS slot to the memory. The method also includes performing the live partition mobility of the inactive virtual machine using the memory that is replicated with PKS data.

In some embodiments, a computer system includes a processor set. The computer system also includes a set of one or more computer-readable storage media. The computer system also includes program instructions, collectively stored in the set of one or more computer-readable storage media, for causing the processor set to perform the following computer operations: monitoring virtual machines requesting platform keystore (PKS) slots; determining that live partition mobility is to be performed of an inactive virtual machine that has a PKS slot; allocating memory to the inactive virtual machine; replicating PKS data associated with the PKS slot to the memory; and performing the live partition mobility of the inactive virtual machine using the memory that is replicated with PKS data.

In some embodiments, a computer program product comprising a set of one or more computer-readable storage media, and program instructions, collectively stored in the set of one or more storage media, for causing a processor set to perform computer operations that perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement live partition mobility of inactive virtualized machines having enabled platform key store in some embodiments.

FIG. 2 is a diagram illustrating VM migration in some embodiments.

FIG. 3 is a flow diagram illustrating a method of migrating inactive VM with PKS enabled in some embodiments.

FIG. 4 illustrates tracking of PKS slot requests in some embodiments.

FIG. 5 is a diagram illustrating prioritization and allocation of vPMEM in some embodiments.

FIG. 6 is a diagram illustrating replication of PKS data in some embodiments.

FIG. 7 is a diagram illustrating performance of live partition mobility in some embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as algorithm code 200 that can implement live partition mobility of inactive virtualized machines having enabled platform key store. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

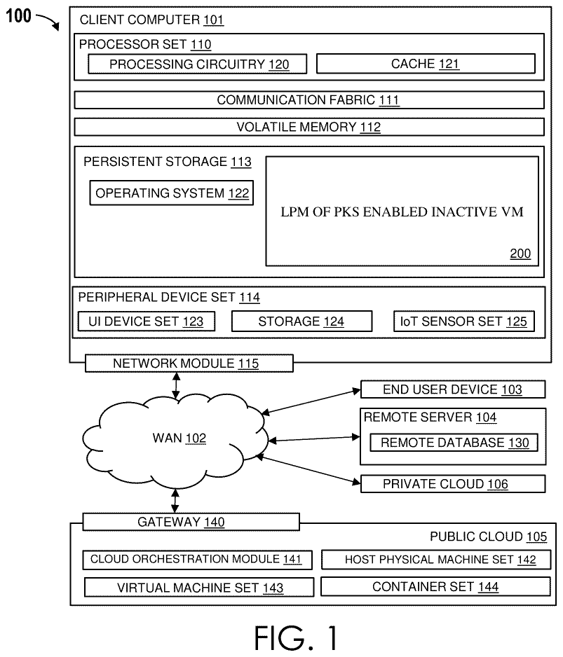

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Virtual machine (VM) migration is a feature in virtualization technologies, allowing for the movement of VM instances between physical hosts while maintaining continuous service availability.

A platform keystore (PKS) is a security feature, a secure storage facility, within a computing platform, which provides a centralized repository for storing and managing cryptographic keys and certificates. A platform keystore feature creates an encrypted non-volatile store.

Examples of PKS usage include, but are not limited to, boot device encryption, self-encrypting drives, unlocking encrypted logical volumes without requiring a passphrase, public key and certificate protection, provision of a lockable flash that is accessible during early initial program load (IPL) of the partition, which then can be locked down from further access.

Live migration involves migrating a virtual machine (VM)'s memory state, central processing unit (CPU) and input/output (I/O) device configuration and state, from the source host system to the target host system.

Virtual Persistent Memory (vPMEM) is a computer platform (e.g., computer system, computer server) feature, which presents a portion of the installed standard system dynamic random access memory (DRAM) dual in-line memory modules (DIMMs) as non-volatile DIMM (NVDIMM) devices to an operating system. The “virtual” qualifier denotes that this differs from true persistent memory since system DRAM is volatile memory. System DRAM will lose its contents when the physical server is powered off.

Secure computing is of growing interest in the industry. Computer systems and their operating systems support a variety of secure encryption technologies to cater the market. Occurrences of situations like unexpected power outages, hardware failure, overheating, power supply issues, resource exhaustion, environmental factors and hardware aging, and/or others, may call for moving VMs from a source central electronic complexes (CEC) to another CEC (herein referred to as destination CEC). CECs are hardware that computer system runs. For example, the CEC provides a number of general purpose processors and special processors.

Live Partition Mobility (LPM) is a technique that migrates VMs from one CEC to another, e.g., from one computer system to another computer system. For example, Live Partition Mobility allows the movement or migration a partition from one physical machine to another. If PKS is involved in one or more inactive VM's being migrated, Live Partition Mobility operation fails. An inactive VM is a VM that is not operational. For instance, a VM may become inactive because there is a failure in the VM. For successful migration operations, administrators activate the individual inactive VMs holding PKS keys. Activating the VM may not always be possible, for example, due to one or more following reason: Unavailability of Resources (memory, processors, etc.) required to activate the partition; Issues with storage area network (SAN) and/or network security considerations; energy efficiency and cooling; minimizing maintenance risks; compatibility issues; unsupported versions; compliance with policies.

In some embodiments, a system and method is provided to perform LPM operation of PKS enabled VMs in inactive state.

In some embodiments, a system and/or method implements a privileged hypervisor software interface residing within hypervisor to perform the following operations: For example, the system and/or method tracks PKS slot requests made by individual virtual machines; Allocates vPMEM to each partition (e.g., VM) that initiates a PKS slot from the hypervisor; Upon Allocation of vPMEM to the corresponding VM, the hypervisor looks for PKS data belonging to the VM being migrated and then replicates the PKS data into the allocated vPMEM; Replicates the individual PKS slot(s) data present in the hypervisor to the respective VM's vPMEM.

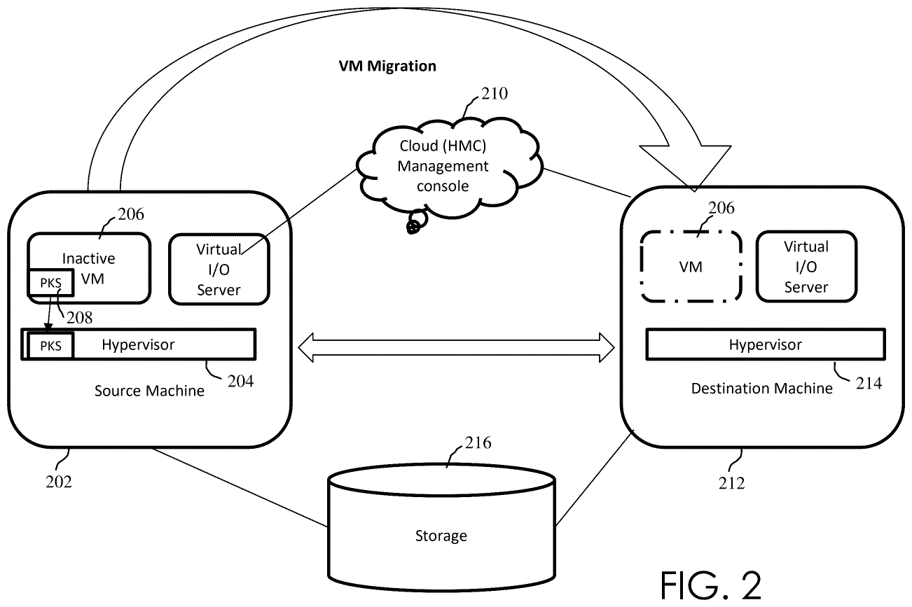

FIG. 2 is a diagram illustrating VM migration in some embodiments. A source machine 202 includes a hypervisor 204 that supports a VM 206. This VM 206 runs an application or operation that involves PKS 208, and has become inactive. Cloud or hardware management console (HMC) 210 can be a hardware appliance that can configure and manage server hardware and virtualization components. A system and/or method in some embodiments allows for migration of the inactive VM 206 to a destination machine 212 running a hypervisor 214. Storage 216 is a storage device that stores data, accessed and/or used by source machine 202 and destination machine 212.

The system and/or method tracks (or keeps track of) PKS slot requests arising out of VMs and slot approval from a hypervisor. The system and/or method creates vPMEM devices. The system and/or method allocates vPMEM to every partition (e.g., VM) that initiates a PKS slot from the hypervisor. The system and/or method replicates the individual PKS slot(s) data present in hypervisor to the respective VM's vPMEM. The system and/or method informs the hypervisor about the presence of PKS in vPMEM device when the hypervisor detects a migration operation of an inactive VM(s) containing PKS keys. The hypervisor performs migration operation as PKS is present in the vPMEM device. The system and/or method replicates the PKS details in vPMEM of the newly migrated LPAR to a target hypervisor. In some embodiments, the system and/or method allows PKS enabled inactive VMs to be migrated to target CECs.

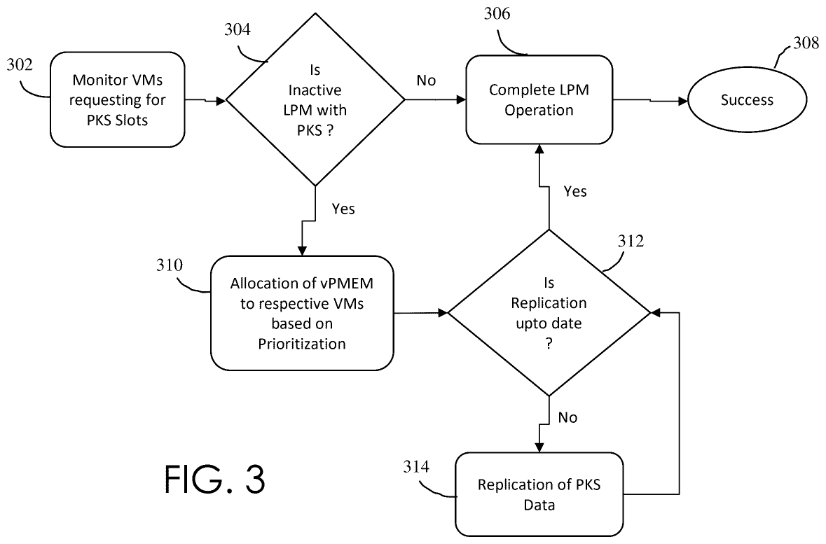

FIG. 3 is a flow diagram illustrating a method of migrating inactive VM with PKS enabled in some embodiments. A processor that is running a software interface residing within a hypervisor may perform one or more operations shown in FIG. 3. At 302, a processor monitors VMs requesting for PKS slots. A PKS slot refers to a memory space, reserved for storing PKS data. At 304, the processor determines whether there exists an inactive VM with PKS that is being migrated, that is, live partition mobility (LPM) is to be performed of an inactive virtual that has one or more PKS slots. If there are no inactive MV with PKS being migrated, at 306 VM migration is performed via LPM operation. At 308, successful migration can be indicated.

If at 304, if the processor determines that there exists an inactive VM with PKS being migrated, e.g., that live partition mobility is to be performed of an inactive virtual machine that has a PKS slot, at 310, the processor allocates a memory to respective VMs. For example, the processor allocates vPMEM to respective VMs. In some embodiments, the processor allocates memory to respective VMs based on prioritization. For example, vPMEM is allocated on a source machine that is accessible by hypervisor. By way of example, vPMEM can be a DRAM-based memory allocated from a computer system memory.

At 312, the processor determines whether replication is up to date. If replication is not up to date, at 314, the processor performs replication of PKS data, and proceeds to 312 to determine again whether replication is up to date. For example, the processor replicates PKS data associated with the PKS slot to the memory, e.g., repeating replicating the PKS data associated with the PKS slot to memory (e.g., vPMEM) until the memory (e.g., vPMEM) includes up-to date replication of the PKS slot. If replication is up to date, at 306, the processor completes LPM operation of migrating the inactive VM, e.g., using the memory that is replicated with PKS data. In some embodiments, migration is triggered from a hardware management console (HMC) which communicates with a hypervisor (or the software interface on the hypervisor). At 308, successful migration can be indicated.

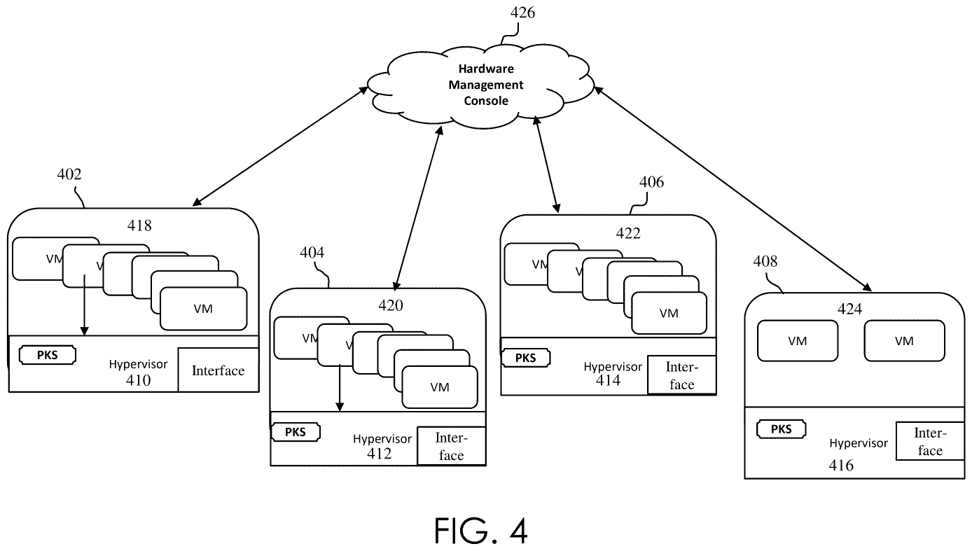

FIG. 4 illustrates tracking of PKS slot requests in some embodiments. A machine runs a hypervisor which hosts one or more VMs, e.g., as shown at 402, 404, 406, 408. An interface, referred also as privileged hypervisor software interface, resides within hypervisor. There can be an interface per hypervisor. For example, an interface resides within hypervisor at 410, an interface resides within hypervisor at 412, an interface resides within hypervisor at 414, an interface resides within hypervisor at 416. An interface tracks PKS slot request made by the individual VMs. By way of example, an interface residing within hypervisor 410 tracks PKS slot request made by one or more VMs 418, an interface residing within hypervisor 412 tracks PKS slot request made by one or more VMs 420, an interface residing within hypervisor 414 tracks PKS slot request made by one or more VMs 422, an interface residing within hypervisor 416 tracks PKS slot request made by one or more VMs 424. Hardware management console (HMC) 426 can be a hardware appliance that can be used to configure and control one or more managed systems or machines 402, 404, 406, 408. HMC 426 can be used to create and manage logical partitions. Upon identifying a PKS slot request, an interface residing within hypervisor proceeds with prioritization activity.

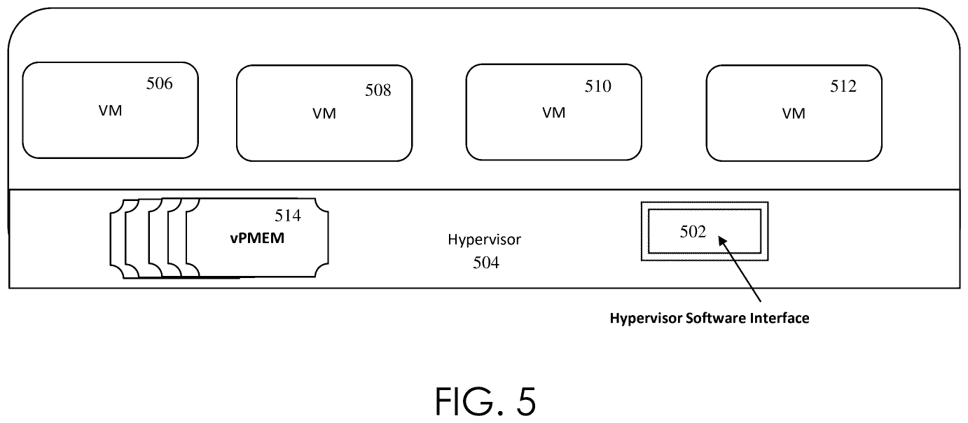

FIG. 5 is a diagram illustrating prioritization and allocation of vPMEM in some embodiments. An interface 502 residing within hypervisor ranks VMs 506, 508, 510, 512, based on one or more criteria such as workload, criticality of workloads and other options, which are configurable. By way of example, VM 506 may be ranked with priority of 1 as containing critical workload; VM 508 may be ranked with priority of 2 as containing medium workload; VM 510 may be ranked with priority of 3 as containing low priority workload; VM 512 may be ranked with priority of 4 as containing idle workload. In some embodiments, VMs with higher priority may have precedence for vPMEM allocation. For instance, vPMEM allocation may be performed in the order of highest priority to lowest priority. Based on the ranking, the interface 502 recommends an action to a corresponding hypervisor 504. Hypervisor 504 acts on the recommendation. Actions performed based on the recommendation include creation of vPMEM modules 514, where hypervisor 504 looks for available persistence memory slots, creates vPMEM and allocates it to the requesting VM.

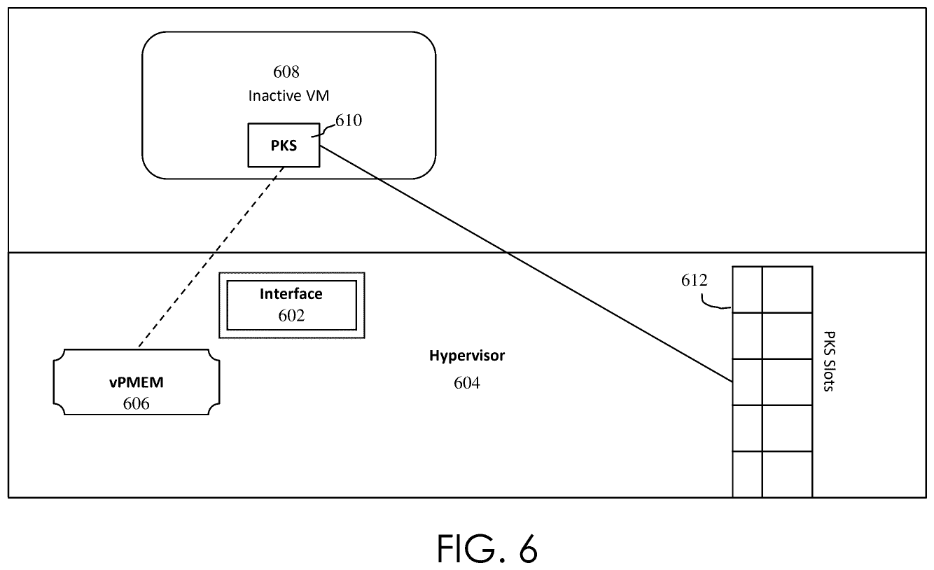

FIG. 6 is a diagram illustrating replication of PKS data in some embodiments. Upon allocation of vPMEM 606 to the corresponding virtual machine 608, hypervisor 604, e.g., the interface 602 residing on the hypervisor 604, looks for PKS data (data of PKS 610) from PKS slots 612 belonging to the VM being migrated 608 and then replicates the data into the allocated vPMEM 606. vPMEM 606 and PKS slots 612 can be memory space accessible by the hypervisor 604. For example, hypervisor 604 searches for PKS data associated with PKS slot that the corresponding virtual machine 608 has.

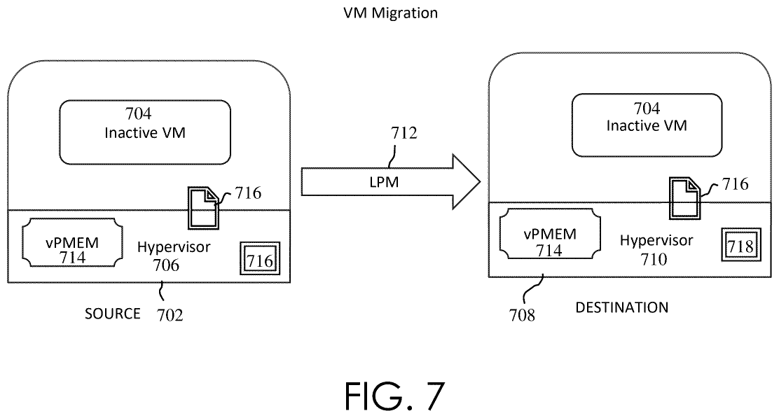

FIG. 7 is a diagram illustrating performance of live partition mobility in some embodiments. As PKS data replication has taken into effect, corresponding VMs are migrated to destination machines using an inactive live partition mobility process. Inactive live partition mobility process refers to migrating a VM partition, which became or is inactive, to another computer or another hypervisor. In some embodiments, reference files detailing PKS data replication are also migrated. Those reference files are referred for action post LPM operation.

For example, performing live partition mobility 712 includes migrating an inactive VM 704 hosted by hypervisor 706, from a source machine 702, to a destination machine 708 for hosting by hypervisor 710 running on that destination machine 708. Replicated PKS data on vPMEM 714 is migrated to the hypervisor 710 running on destination machine 708. Reference files 716 can also be migrated to the destination machine 708. Hypervisor 706 has interface (hypervisor software interface) 716 within that hypervisor 706. Hypervisor 710 has interface (hypervisor software interface) 718 within that hypervisor 710.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in some embodiments” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
monitoring, by an interface residing within a hypervisor running on a processor, virtual machines requesting platform keystore (PKS) slots;
determining, by the interface residing within a hypervisor running on a processor, that live partition mobility is to be performed of an inactive virtual machine that has a PKS slot;
allocating, by the interface residing within a hypervisor running on a processor, memory to the inactive virtual machine;
replicating, by the interface residing within a hypervisor running on a processor, PKS data associated with the PKS slot to the memory; and
performing the live partition mobility of the inactive virtual machine using the memory that is replicated with PKS data.

2. The computer-implemented method of claim 1, wherein the allocating memory to the inactive virtual machine includes allocating virtual persistent to the inactive virtual machine.

3. The computer-implemented method of claim 1, further including:
repeating replicating the PKS data associated with the PKS slot to memory until the memory includes up-to date replication of the PKS slot.

4. The computer-implemented method of claim 1, wherein the virtual persistent memory is allocated based on determining priority of the inactive virtual machine.

5. The computer-implemented method of claim 4, wherein the priority is determined based on workload of the inactive virtual machine.

6. The computer-implemented method of claim 1, further including searching for the PKS data associated with the PKS slot for replication.

7. The computer-implemented method of claim 1, wherein the performing the live partition mobility includes migrating at least the inactive virtual machine to a destination machine and the replicated PKS data stored on the memory.

8. A computer program product comprising:
one or more computer-readable storage media; and
program instructions stored on the one or more storage media to perform operations comprising:
monitoring virtual machines requesting platform keystore (PKS) slots;
determining that live partition mobility is to be performed of an inactive virtual machine that has a PKS slot;
allocating memory to the inactive virtual machine;
replicating PKS data associated with the PKS slot to the memory; and
performing the live partition mobility of the inactive virtual machine using the memory that is replicated with PKS data.

9. The computer program product of claim 8, wherein the allocating memory to the inactive virtual machine includes allocating virtual persistent to the inactive virtual machine.

10. The computer program product of claim 8, wherein the operations further include: repeating replicating the PKS data associated with the PKS slot to memory until the memory includes up-to date replication of the PKS slot.

11. The computer program product of claim 8, wherein the virtual persistent memory is allocated based on determining priority of the inactive virtual machine.

12. The computer program product of claim 11, wherein the priority is determined based on workload of the inactive virtual machine.

13. The computer program product of claim 8, wherein the performing the live partition mobility includes migrating at least the inactive virtual machine to a destination machine and the replicated PKS data stored on the memory.

14. The computer program product of claim 8, the operations further include searching for the PKS data associated with the PKS slot for replication.

15. A computer system comprising:
a processor set;
a set of one or more computer-readable storage media;
program instructions, collectively stored in the set of one or more computer-readable storage media, for causing the processor set to perform the following computer operations:
monitoring virtual machines requesting platform keystore (PKS) slots;
determining that live partition mobility is to be performed of an inactive virtual machine that has a PKS slot;
allocating memory to the inactive virtual machine;
replicating PKS data associated with the PKS slot to the memory; and
performing the live partition mobility of the inactive virtual machine using the memory that is replicated with PKS data.

16. The computer system of claim 15, wherein the allocating memory to the inactive virtual machine includes allocating virtual persistent to the inactive virtual machine.

17. The computer system of claim 15, wherein the computer operations further include repeating replicating the PKS data associated with the PKS slot to memory until the memory includes up-to date replication of the PKS slot.

18. The computer system of claim 15, wherein the virtual persistent memory is allocated based on determining priority of the inactive virtual machine.

19. The computer system of claim 18, wherein the priority is determined based on workload of the inactive virtual machine.

20. The computer system of claim 15, wherein the performing the live partition mobility includes migrating at least the inactive virtual machine to a destination machine and the replicated PKS data stored on the memory.
